(19) United States
(12) Patent Application Publication
(10) Pub. No.: US 2002/0056083 A1
(43) Pub. Date: May 9, 2002

(54) System and method for picture-in-browser scaling

(76) Inventor: Anthony F. Istvan, Snoqualmie, WA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/747,309

(22) Filed: Dec. 20, 2000

Related U.S. Application Data
(63) Continuation-in-part of application No. 09/631,437, filed on Aug. 2, 2000.
(63) Continuation-in-part of application No. 09/591,547, filed on Jun. 8, 2000.
(60) Provisional application No. 60/193,046, filed on Mar. 29, 2000.

(51) Int. Cl. H04N 7/16

(52) U.S. Cl. 725/1

(57) ABSTRACT

A method of viewing multi-media content on a television having a display area includes providing a remote control to control images being displayed on the display area. A first image of first type is displayed on the display area. The first image substantially fills the display area and has a first length and a first width. The first image has a length-to-width ratio of a first value. A first instruction is initiated on the remote control to modify the first image being displayed on the display area. A reduced image of the first image is displayed on the display area overlaid on a second image of second type in response to the first instruction. The reduced image of the first image has a second length and a second width and has a length-to-width ratio of a second value. The first and second length-to-width ratios are substantially the same.

### RELATED APPLICATIONS

The present application is related to and claims priority from provisional application U.S. Serial No. 60/193,046 (Attorney Docket: 020492-000100US), filed Mar. 29, 2000, with inventor Anthony F. Istvan, which is hereby incorporated by reference in its entirety. The present application is also a continuation-in-part of nonprovisional application, U.S. Ser. No. 09/631,437 (Attorney Docket: 02492-000600US), entitled “System and Method For Picture-in-Browser Scaling,” filed on Aug. 2, 2000, with inventor Anthony F. Istvan, which is in turn a continuation-in-part of nonprovisional application, U.S. Ser. No. 09/591,547 (Attorney Docket: 020492-000200US), entitled “L Configured User Interface to TV and Internet Content,” filed on Jun. 8, 2000, with inventors Anthony F. Istvan and Lisa M. Wilkins, which are both hereby incorporated by reference in their entirety.

### FIELD OF THE INVENTION

The present application pertains to the fields of television reception and Internet access. More particularly, the present application pertains to a user interface to television broadcasts and Internet content.

### BACKGROUND

Televisions and Internet technologies are beginning to converge. In particular, access to the World Wide Web via an Internet-enabled television system is progressing and becoming more popular. However, prior art user interfaces for such systems are limited in their capabilities and do not provide for user-friendly access to both broadcast television (TV) and Internet content.

U.S. Pat. No. 6,034,689, entitled “Web Browser Allowing Navigation Between Hypertext Objects Using Remote Control,” discloses browser software implemented in a set-top box which allows a user to navigate using a remote control through World Wide Web pages. This browser software has limited capabilities and comprises a relatively simple user interface which allows for selection of hypertext anchors. In this simple user interface, access to Web pages is provided for separately from access to broadcast TV.

### SUMMARY

The present invention provides for user-friendly access to both broadcast television and Internet content via a single integrated user interface. According to one embodiment of the present invention, a method of viewing multi-media content on a television having a display area includes providing a remote control to control images being displayed on the display area. A first image of first type is displayed on the display area. The first image substantially fills the display area and has a first length and a first width. The first image has a length-to-width ratio of a first value. A first instruction is initiated on the remote control to modify the first image being displayed on the display area. A reduced image of the first image is displayed on the display area overlaid on a second image of second type in response to the first instruction. The reduced image of the first image has a second length and a second width and has a length-to-width ratio of a second value. The first and second length-to-width ratios are substantially the same.

### BRIEF DESCRIPTION OF THE DRAWINGS

FIG. 1 is a schematic diagram depicting a system 100 for distributing Internet content, in addition to TV content, in accordance with an embodiment of the present invention.

FIG. 2 is an illustrative screen frame of a display with a full-size video being displayed.

FIG. 3 depicts an example layout 300 of a user interface (UI) which has been activated in accordance with an embodiment of the present invention.

FIG. 4 is an illustrative screen frame of a UI which has been activated in accordance with an embodiment of the present invention.

FIG. 5 depicts an example layout 500 of a UI with a user submenu activated in accordance with an embodiment of the present invention.

FIG. 6 depicts an example layout 600 of a UI with a TV submenu 602 activated in accordance with an embodiment of the present invention.

FIG. 7 depicts an example layout 700 of a UI with television listing controls in the context-sensitive area 304 in accordance with an embodiment of the present invention.

FIG. 8 is an illustrative screen frame of a UI in a TV listing mode which provides an electronic programming guide (EPG) in accordance with an embodiment of the present invention.

FIG. 9 depicts an example layout 900 of a UI with a browser submenu 902 activated in accordance with an embodiment of the present invention.

FIG. 10 depicts an example layout 1000 of a UI with browser controls in the context-sensitive area 304 in accordance with an embodiment of the present invention.

FIG. 11 is an illustrative design for a remote control 1100 in accordance with an embodiment of the present invention.

FIGS. 12-19 illustrates methods of navigating between a video image and a browser image in accordance of specific embodiments of the present invention.

### DESCRIPTION OF THE SPECIFIC EMBODIMENTS

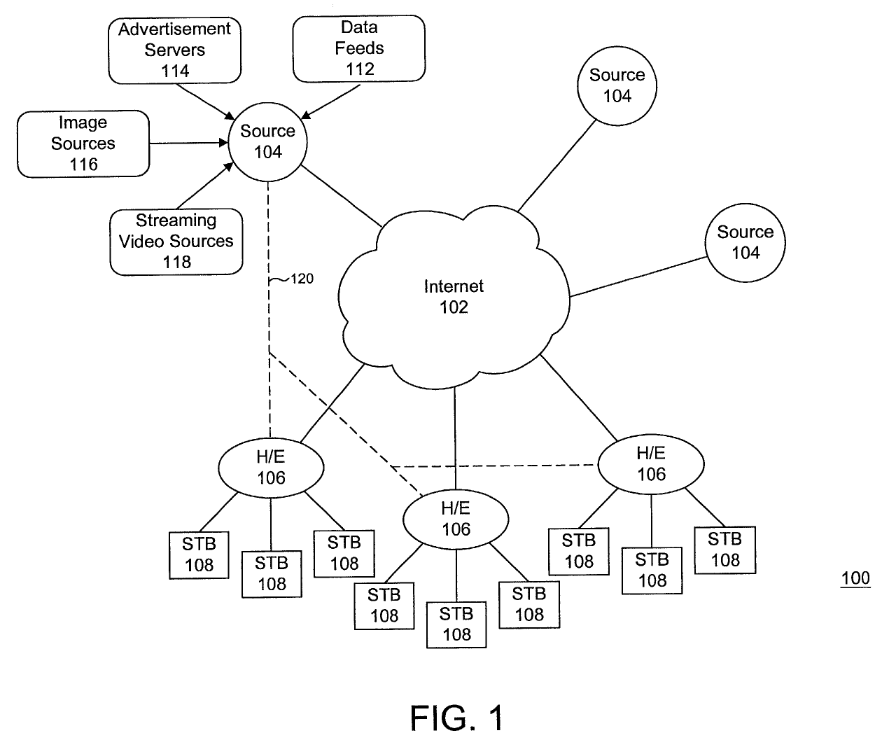

FIG. 1 is a schematic diagram depicting a system 100 for distributing Internet content, in addition to TV content, in accordance with an embodiment of the present invention. In accordance with an embodiment of the present invention, the system 100 is integrated with a cable TV distribution system. Such cable TV distribution systems may include cable headends and are well known in the art.

The system 100 includes an Internet 102, a plurality of content sources 104, a plurality of distribution centers (depicted as headends or H/E) 106, and a plurality of client terminals (depicted as set top boxes or STB) 108. In addition, a content source 104 is depicted as receiving data from data feeds 112, advertisement servers 114, image sources 116, and streaming video sources 118.

The plurality of content sources 104 are coupled to the Internet 102. For example, a content source 104 may comprise a web site portal such as Go2Net.com, or a news web site such as CNN.com, or other types of sources. Each content source 104 may have various data feeds 112, servers 114, and sources 116/118 coupled to it.

For example, news or stock quote feeds 112 may be fed into the content source 104. Servers 114 may provide advertisements for insertion into multimedia content delivered by the content source 104. Sources 116/118 may provide images 116, streaming video 118, and other content to the content source 104. Various other feeds, servers and sources may also be coupled to the content source 104.

The Internet 102 comprises a network of networks and is well known in the art. Communications over the Internet 102 are accomplished using standard protocols such as TCP/IP (transmission control protocol/internet protocol) and other protocols. The Internet 102 is coupled to the plurality of distribution centers 106. For example, a distribution center 106 may comprise a cable headend (H/E).

Each distribution center 106 is coupled to a plurality of client terminals 108. For example, a client terminal 108 may comprise a set top box (STB), a personal computer, an interactive television set, or another type of communication device.

In alternative or in addition to the Internet 102 being used to distribute multimedia content from the content sources 104 to distribution centers 106, communications channels or networks 120 apart from the Internet 102 may couple one or more content source 104 to one or more distribution center 106. One example of such an alternate path for communications is illustrated in FIG. 1. Other configurations are also possible and meant to be included within the scope of the present invention.

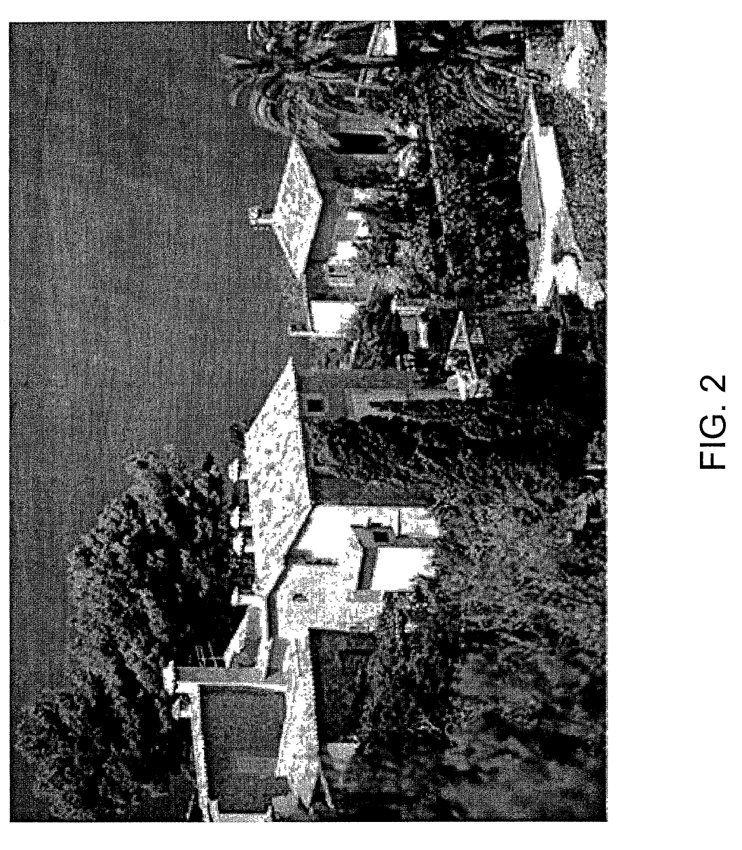

FIG. 2 is an illustrative screen frame of a display with a full-size video being displayed. While the screen frame is a still frame, the actual video is a motion video comprising a multitude of frames in sequence.

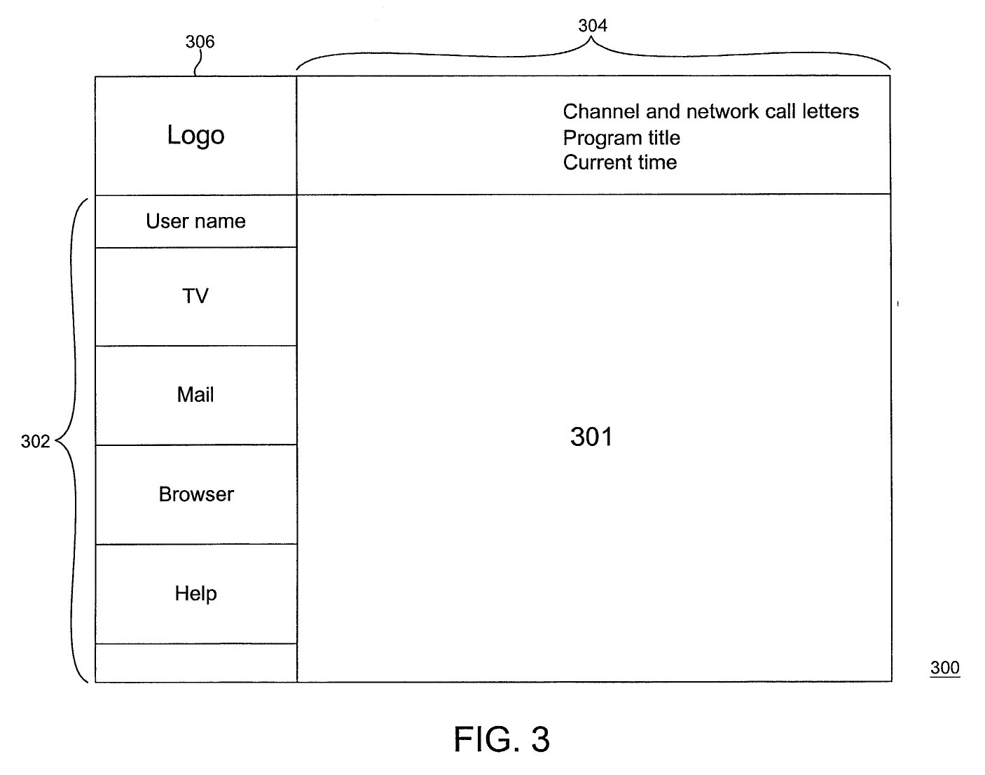

FIG. 3 depicts an example layout 300 of a user interface (UI) which has been activated in accordance with an embodiment of the present invention. In one embodiment, when the UI is activated, the full-size display (see FIG. 2) shrinks in an “animated” fashion (i.e. with visible motion to a viewer) to occupy a reduced-size area 301 of the display. Alternatively, when the UI is activated, the L configured UI may be superimposed (overlaid) over the full-size display. For example, shrinking the full-size display may be used if the display is showing TV or video content, while superimposing over the full-size display may be used if the display is showing pages which do not scale well. A “menu” button on a remote control unit may be used to activate and deactivate the UI.

The UI includes a group of permanent controls 302 on a first side of the reduced-size area 301, a context-sensitive area 304 on a second side of the reduced-size area 301 (perpendicular to the first side), and a logo area 306 at the intersection of the two sides. In the example layout 300 shown in FIG. 3, the permanent controls 302 include user (“user name”), TV, mail, browser, and help controls or control icons.

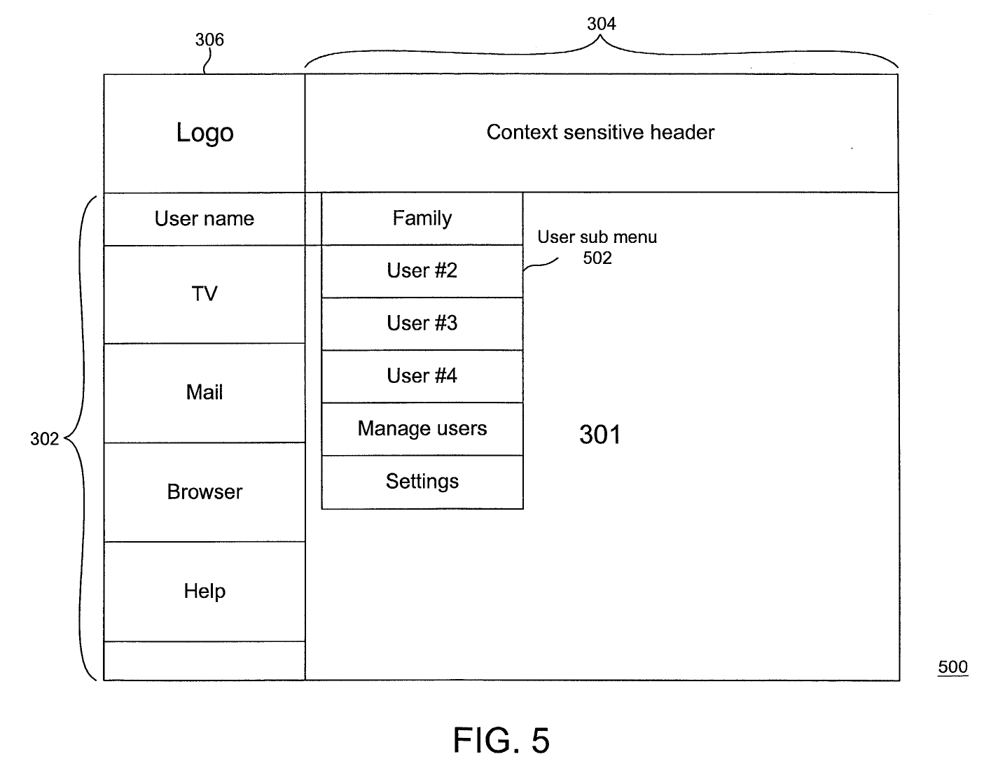

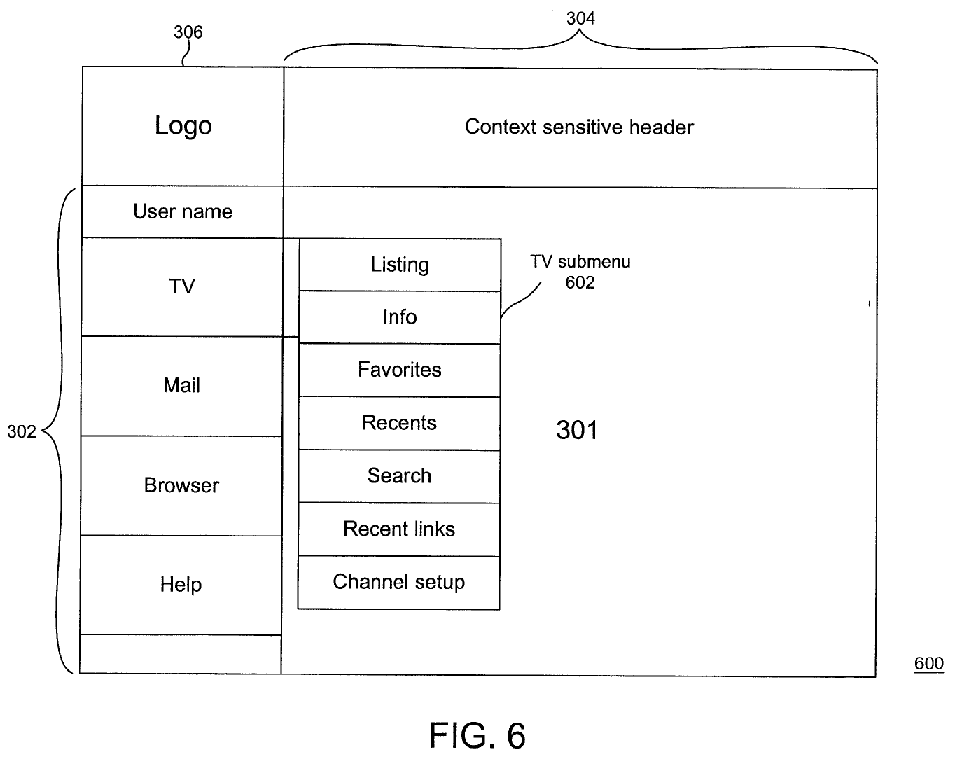

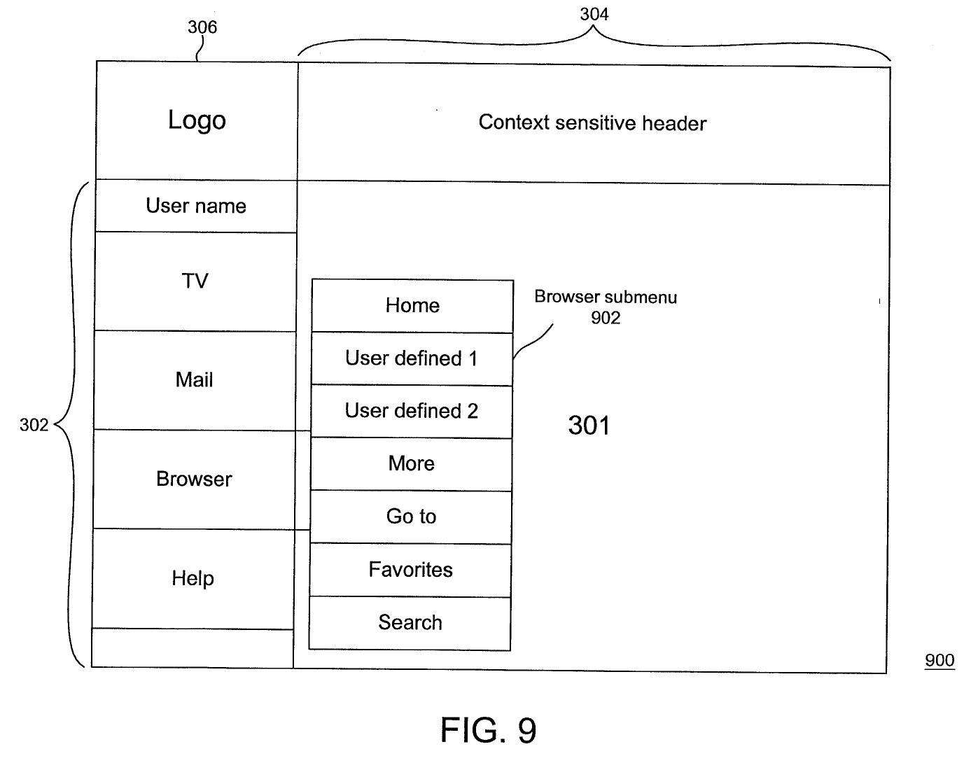

Selection of these permanent control icons typically reveals a corresponding submenu. For purposes of illustration, described in detail below are a selection of such submenus. First, an example of a user submenu 502 is described below in relation to FIG. 5. Second, an example of the TV submenu 602 is described below in relation to FIG. 6. Third, an example of a browser submenu 902 is described below in relation to FIG. 9.

The context-sensitive area 304 may display different information (non-selectable items) and control icons (selectable items) depending upon the content in the display area 301. Initially, the context-sensitive area 304 may display information on the TV content currently being displayed in the display area 301. The information may include, for example, channel number/network call letters, program title, and current time.

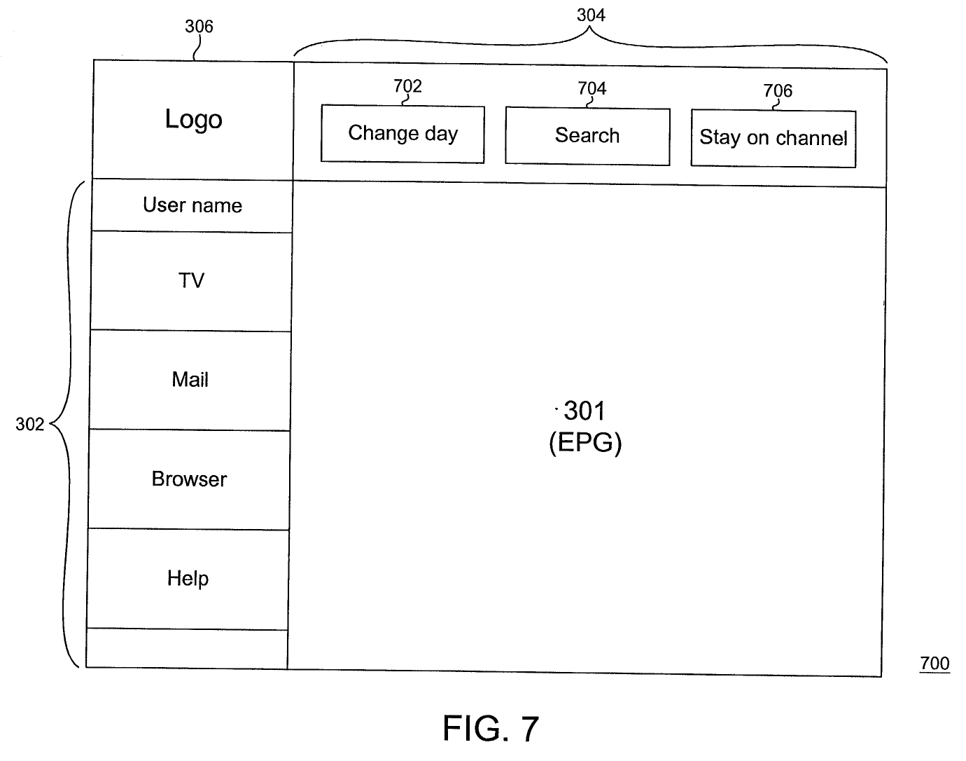

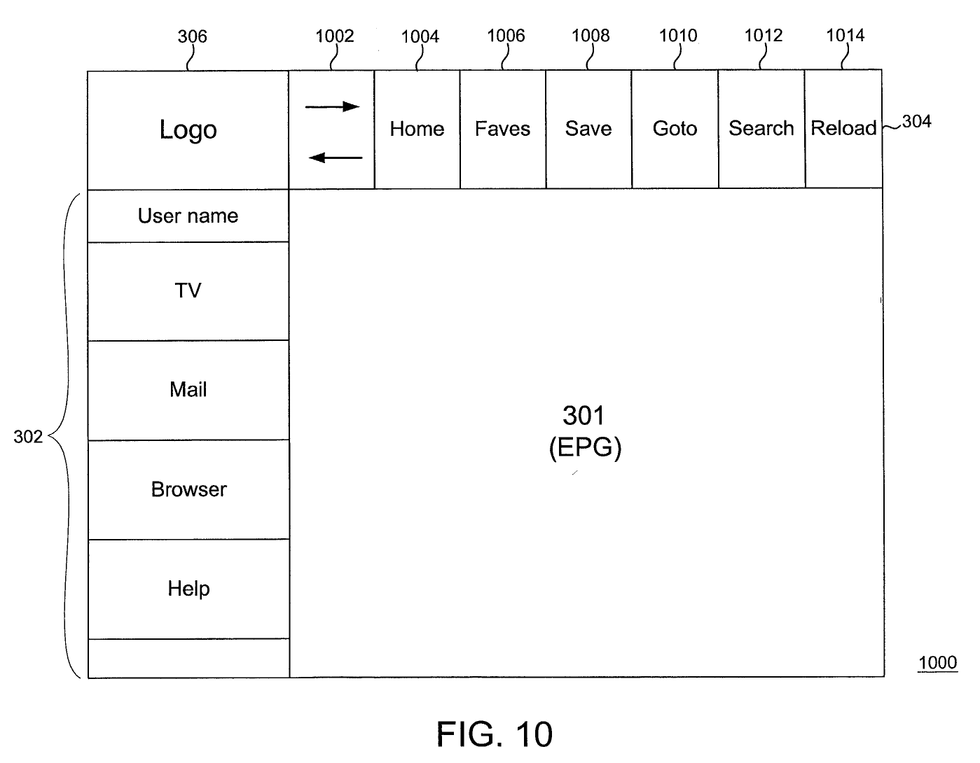

As the content in the display area 301 varies, so will the information and control icons in the context-sensitive area 304. For example, first, when display area 301 contains TV content, then context-sensitive area 304 may have the information shown in FIG. 3. Second, when the display area 301 contains electronic programming guide (EPG) content, then context-sensitive area 304 may have the controls described in relation to FIG. 7. Third, when display area 301 contains web content, then context-sensitive area 304 may have the controls described in relation to FIG. 10.

The logo area 306 may display, for example, a logo and name for a service provider. In this example, the service provider is named Charter Communications™.

While the particular layout of FIG. 3 shows a “L” configured UI along the top and left sides of the display, other “L” configurations are also contemplated and within the scope of the present invention. For example, the “L” configured UI may instead be along the bottom and left sides, or the bottom and right sides, or the top and right sides.

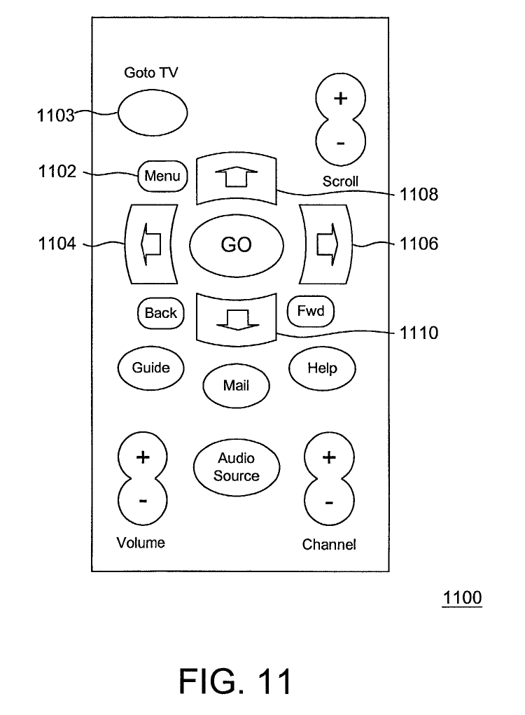

In accordance with an embodiment of the present invention, a first pair of arrows on a remote control navigates among the permanent controls, and a second pair of arrows (perpendicular to the first pair) navigates among the context-sensitive controls. Switching between navigation among the permanent controls and navigation among the context-sensitive controls occurs automatically upon switching between using the first pair of arrows and using the second pair of arrows. An example of a remote control with such arrows is shown in FIG. 11 which is described below.

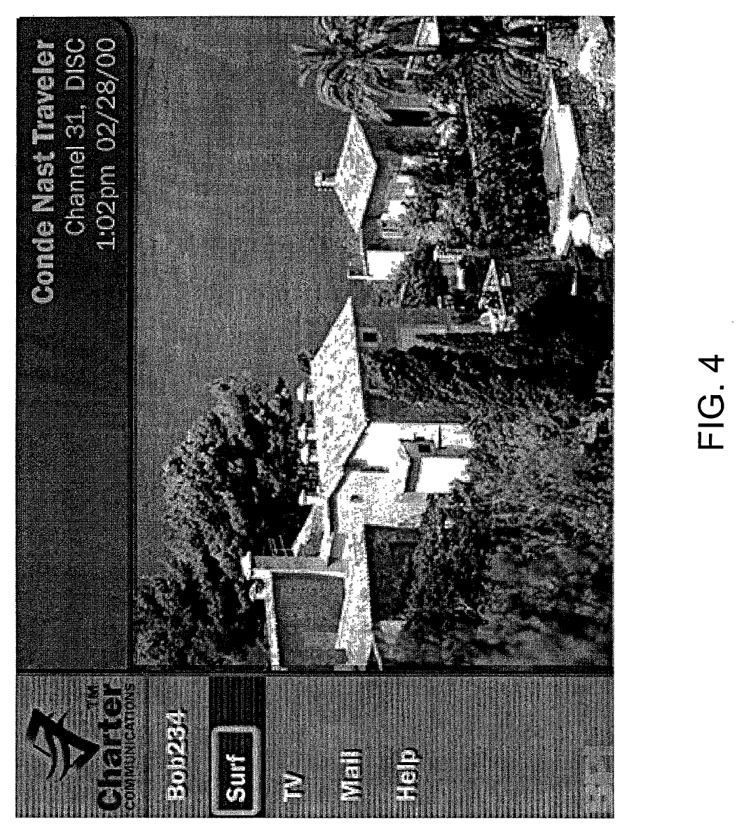

FIG. 4 is an illustrative screen frame of a UI which has been activated in accordance with an embodiment of the present invention. The frame shown in FIG. 4 is an implementation in close (but not exact) correspondence to the layout 300 of FIG. 3. Like the layout 300 in FIG. 3, the UI of FIG. 4 has permanent controls on the left side, a context-sensitive area on the top, and a service provider's logo at the upper left corner.

Regarding the permanent controls, “Bob234” is an example name of a currently active user. The “Surf” control corresponds to the browser control. Regarding the context-sensitive area, “Conde Nast Traveler” corresponds to the program title. “Channel 31, DSC” corresponds to the channel/network call letters. And, finally, “1:02 pm Feb. 28, 2000” corresponds to the current time (and date).

FIG. 5 depicts an example layout 500 of an UI with a user submenu 502 activated in accordance with an embodiment of the present invention. The user submenu 502 is activated by selecting the “user name” on-screen control from the group of permanent controls 302. The user submenu 502 may include various selections.

The “family” user is the default selection when the UI is activated. In one embodiment, the family user will be able to access only content which is accessible to all other users. In other words, the family user will have a “permission space” which is the intersection of permission spaces of all other users. Advantageously, this feature does not require a password to be entered upon turning on the TV. Nevertheless, this feature may be used to prevent children from accessing excessively violent or adult-oriented content. Moreover, the protection provided may extend to both TV and Internet content.

User #2, user #3, . . . , user #N, may be individual user names, each of which may have a password to protect against entry by an unauthorized person. For example, the different users may correspond to members of a family. These user names may be sorted alphabetically in the user submenu 502. When an individual user name is selected and password, if any, entered correctly, then the user name becomes the active user.

The “manage users” and “settings” selections may be used to perform such function as: editing user name, password, and other user-related information for a specified user account; allowing users to block certain emails; allowing a user with administrative privileges to add or remove users and change user privileges; and so on.

FIG. 6 depicts an example layout 600 of a UI with a TV submenu 602 activated in accordance with an embodiment of the present invention. The TV submenu 602 is activated by selecting the “tv” on-screen control from the group of permanent controls 302. The TV submenu 602 may include various selections.

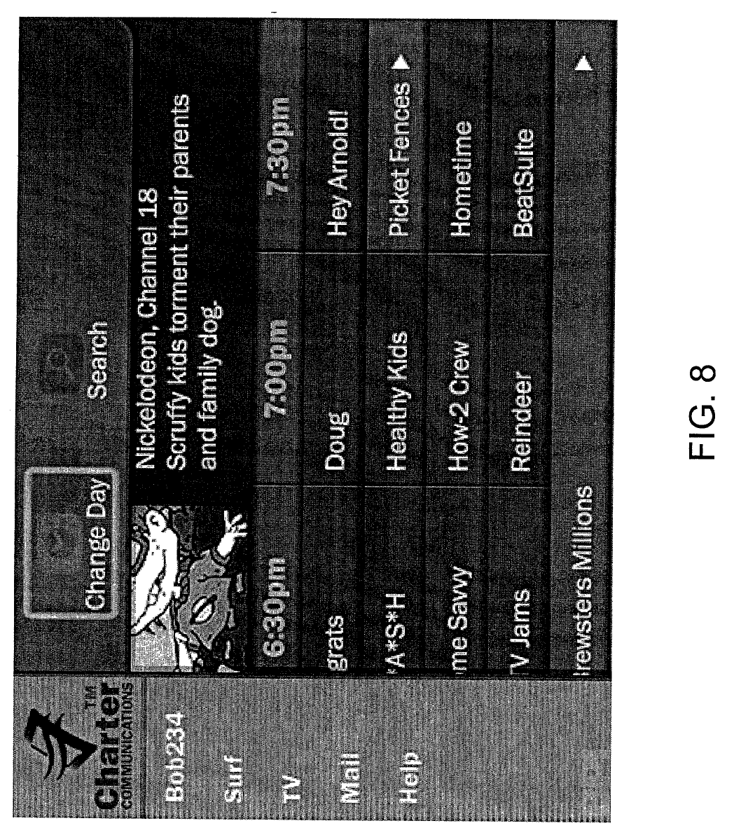

The “listing” selection provides an electronic programming guide (EPG) to broadcast TV content. When the EPG is provide, corresponding controls are provided in the context-sensitive area 304 as described below in relation to FIG. 7. An example of such an EPG within the UI is illustrated in FIG. 8 which is also described below.

The “info” selection provides information relating to the TV program currently being viewed in the display area 301. The information may include a brief description of the program, names of actors/actresses, copyright year, and so on.

The TV “favorites” selection provides a user with a list of his/her favorite TV channels. When a TV channel is selected from the favorite list, then the embedded TV display changes to that channel.

The TV “recents” selection provides small screen video images of the last N (where N is a positive integer) TV channels viewed. For example, if N=9, then video images of the 9 most recently viewed TV channels may be shown in a 3×3 matrix configuration in the embedded display 301. The number N may be fixed, or it may be user selectable.

The TV “search” selection provides a mechanism to search electronic program guide (EPG) listings for a particular program or programs. The search may be by program title, type of program (e.g., “basketball” may be searched to find basketball games being broadcast), by actor/actress, and so on.

These and other selections may be provided in the TV submenu 602. For example, “recent links” and “channel setup” selections are depicted in the TV submenu 602 of FIG. 6. The “recent links” selection provides access to hyperlinks recently received via a mechanism such as an ATVEF (Advanced TV Enhancement Forum) trigger. ATVEF is a cross-industry alliance of companies from broadcast and cable networks, television transport, consumer electronics, and personal computer industries. The “channel setup” selection allows a user to specify which TV channels are included as channels to tune to as part of the channel up/down tuning sequence.

FIG. 7 depicts an example layout 700 of a UI with television listing controls in the context-sensitive area 304 in accordance with an embodiment of the present invention. The television listing controls are provide when the display area 301 is used to provide an electronic programming guide (EPG).

The television listing controls shown in FIG. 7 include a “change day” control, an EPG “search” control, and a “stay on channel” control. The “change day” control allows the user to change the day of the program grid being shown by the EPG. The EPG “search” control provides access to a mechanism to search EPG listings for a particular program or programs. The “stay on channel” control comprises a toggle control to activate/deactivate this option. When the option is deactivated, then the TV tuner actively tunes to the selected channel in the program grid of the EPG. When the option is activated, then the TV tuner remains on the channel that was being displayed before entering the EPG.

FIG. 8 is an illustrative screen frame of a UI in a TV listing mode which provides an electronic programming guide (EPG) in accordance with an embodiment of the present invention. The frame shown in FIG. 8 is an implementation in close (but not exact) correspondence to the layout 700 of FIG. 7. (The frame of FIG. 8, for example, does not show a “stay on channel” toggle control.) The EPG shown provides a programming grid including rows representing different channels, and columns representing different timeslots. Other implementations of an EPG are also possible.

FIG. 9 depicts an example layout 900 of a UI with a browser submenu 902 activated in accordance with an embodiment of the present invention. The browser submenu 902 is activated by selecting the “browser” on-screen control from the group of permanent controls 302. The browser submenu 902 may include various selections.

The “home” selection may provide access to a web page designated by a service provider (e.g., a MSO) as its “home” page. In one embodiment, when going to the home page, the L configured UI retracts, so that the home page is shown on a full-size screen.

The “user defined” selections provide access to specialized web pages which may be focused to various categories of content. For example, the specialized web pages may focus on categories such as news, money, sports, weather, entertainment, and others. Again, in one embodiment, when going to a specialized web page, the L configured UI retracts, so that the specialized page is shown on a full-size screen.

These and other selections may be provided in the browser submenu 902. For example, “more,” “go to,” browser “favorites,” and browser “search” selections are depicted in the browser submenu 902 shown in FIG. 9. The “more” button provides access to other categories of content in addition to those specified by the “user defined” selections described above. The “go to” button provides a query text box which allows a user to specify a URL to be displayed in the browser. The browser “favorites” button provides access to an organized data structure of favorite links. These browser favorites may be provided separately from the TV favorites, or they may be provided together in an integrated data structure. The browser “search” control provides access to a mechanism to search for particular Internet or Web content. The browser search may be provided separately from the EPG search, or they may be provided together in an integrated search feature.

FIG. 10 depicts an example layout 1000 of a UI with browser controls in the context-sensitive area 304 in accordance with an embodiment of the present invention. The browser controls are provided when the display area 301 is used to access World Wide Web content and other similar hyperlinked content.

In the embodiment shown in FIG. 10, the left and right arrows 1002 may be individually selected. The left arrow scrolls or shifts the browser controls one button to the left. For example, in FIG. 10, the left arrow would cause the “home” button 1004 to scroll “behind” the arrows 1002 and a control button (not shown) to the right of the “reload” button 1014 to become visible at the right side of the context-sensitive area 304. Similarly, the right arrow scrolls or shifts the browser controls one button to the right.

In the embodiment shown in FIG. 10, the “home” button 1004 provides access to the web page designated by the user as his/her “home” page. The “faves” or favorites button 1006 provides access to a list of web pages or URLs that the user selects as his/her favorites. The “save” button 1008 enables a user to save a web page currently being displayed as a favorite page. The “go to” button 1010 provides a query text box which allows a user to specify a URL to be displayed in the browser. The “search” button 1012 provides access to a mechanism to search for particular Internet or Web content. The “reload” button 1014 causes the content currently in the display 301 to be refreshed.

Other buttons may be provided to the right of the “reload” button 1014. In one embodiment, the other buttons may include a “print” button, a “find” button, a “send” button, and an “info” button. The “print” button provides for printing, with various options, of the web page being displayed. The “find” button provides for finding a specified text string within the web page being displayed. The “send” button provides for sending an email with the web page being displayed or its URL attached thereto or contained therein. Finally, the “info” button provides additional information about the web page being displayed.

FIG. 11 is an illustrative design for a remote control 1100 in accordance with an embodiment of the present invention. Many other designs with similar functionality are, of course, possible and would be within the scope of the present invention.

The menu button 1102 may be used to activate and deactivate the UI as described above in relation to FIG. 3. The “Go To TV” button 1103 and the “Browser” button 1112 together may be used to navigate between a video display (“video image” ) and a browser display (“browser image” ). As used herein, the video display or image refers to traditional video content displayed on the television. The browser display or image refers contents than the video image displayed on the television, e.g., the UI described above or a client program, such as Netscape Navigator and Microsoft Internet Explorer, that allows users to read hypertext documents on the World Wide Web and navigate the Internet.

The up arrow 1108 and down arrow 1110 may be used to navigate among the permanent controls 302. The left arrow 1104 and right arrow 1106 may be used to navigate among controls in the context-sensitive area 304. Switching between navigation among the permanent controls and navigation among the context-sensitive controls occurs automatically upon switching between using the up/down arrows 1108/1110 and using the left/right arrows 1104/1106. The “Go” button (which may also be designated the “OK” button) selects the screen object currently pointed to and triggers whatever event is associated with the object.

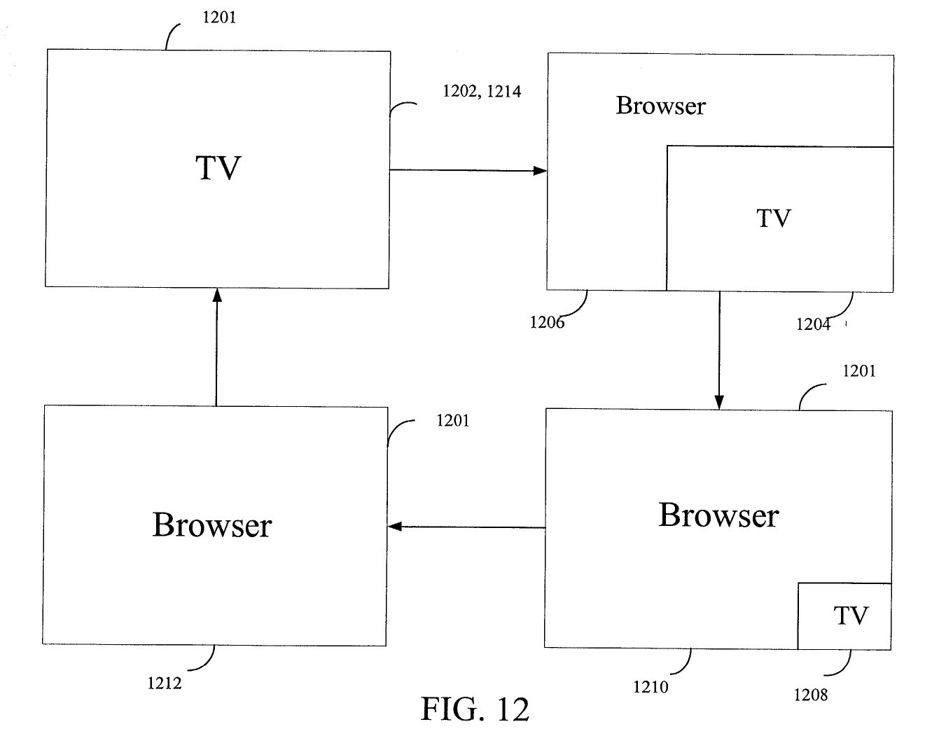

Referring to FIG. 12, in one embodiment, the remote control 1100 includes a button, e.g., the browser button 1112, to navigate between the video image and the browser image in a closed-loop display cycle. A display screen 1201 initially displays a full video image 1202 that completely fills the screen. The browser button 1112 is pressed once to display a reduced video image 1204 and a browser image 1206 of first size simultaneously on the display screen, where the reduced video image 1204 is overlaid on the browser image 1206. That is, the display screen is in a picture-in-browser (“PIB” ) mode. As used herein, the picture-in-browser mode or PIB mode refers to a situation where the video image is overlaid on the browser image, or vice versa. In one embodiment, the set top box is always connected to the Internet so that when the browser button is pressed, the browser image promptly appears without requiring additional steps of connecting to the Internet connection.

After the browser button has been pressed once, if pressed again, the screen displays a further reduced video image 1208 and a browser image 1210 of second size. As shown, the browser image 1210 of second size has increased in size proportionally to the size reduction of the video image 1208, thereby filling the areas of display screen previously filled by the video image 1208. The browser button 1112 is pressed once more to completely fill the display screen 1201 with a browser image 1212. At this time, if the browser button is pressed once again, a full video image 1214 replaces the browser image 1212 to completely fill the screen 1201. Alternatively, rather than displaying the full video image 1214 in a single step, this may be done in multiple steps, where a reduced browser image is overlaid on a video image and successively reduced in size, as explained above in connection with the video image. In one implementation, the above navigational steps may be performed by simply keeping the browser button 1112 pressed rather than successively pressing the button.

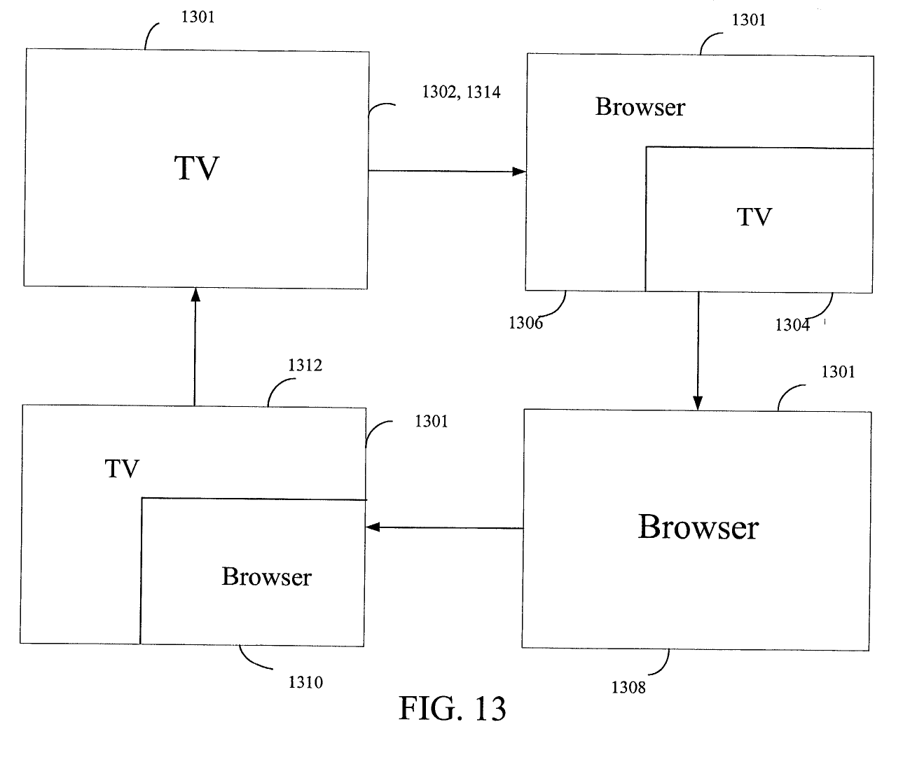

FIG. 13 illustrates another display cycle for the PIB mode according to one embodiment of the present invention. A single button, e.g., the browser button 1112, is used to navigate between the video and browser images. A display screen 1301 initially displays a full video image 1302. The browser button 1112 is pressed once to display a reduced video image 1304 overlaid on a browser image 1306. The browser button 1112 is pressed once more to completely fill the display screen 1301 with a browser image 1308. If pressed once more, a reduced browser image 1310 is overlaid on a video image 1312. Finally, a full video image fills the display screen when the browser button is pressed again, thereby returning to the initial viewing format. In one implementation, the user may move to different stages in the display cycle by simply keeping the browser button pressed. In another implementation, the size reduction of images occurs in a continuous manner rather than discretely, so that a user may shrink the overlaid images to any size he or she wishes.

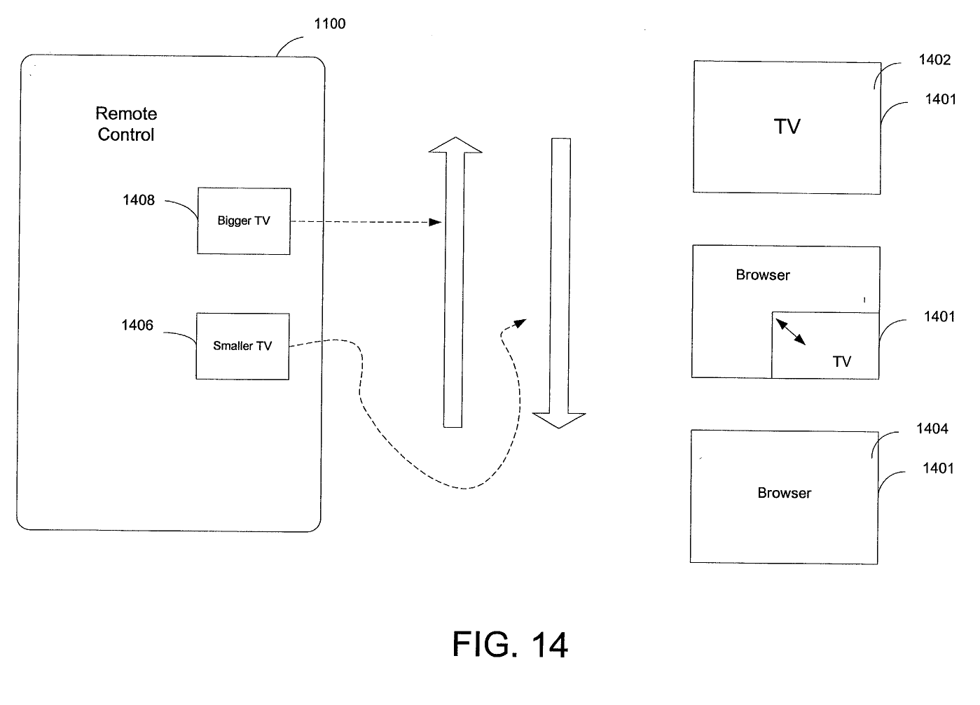

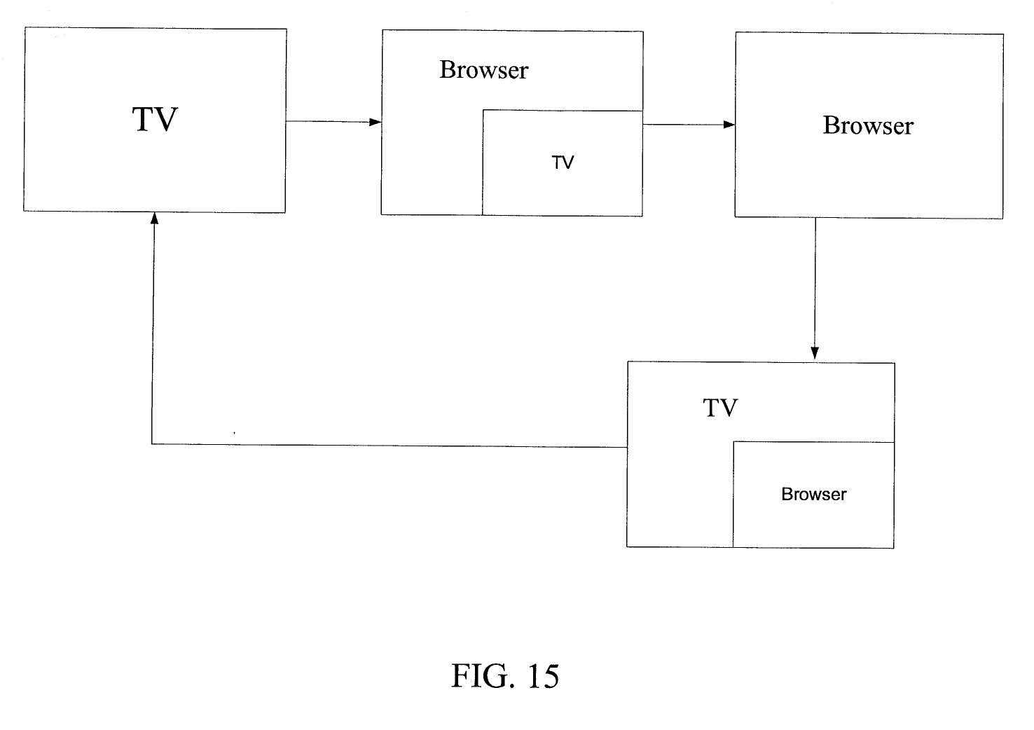

In one embodiment, as shown in FIG. 14, the remote control 1100 includes two buttons, e.g., Smaller TV button 1406 and the Bigger TV button 1408, to navigate between the video and browser images. A display screen 1401 initially displays a full video image 1402. Pressing or keeping the Smaller TV button pressed reduces the size of the video image continuously starting from the top, left corner of the screen. Eventually, the video image disappears from the screen and only a browser image 1404 remains on the screen. Conversely, pressing or keeping the Bigger TV button pressed increases the size of the video image continuously and reverses the effects of pressing the Smaller TV button. In one implementation, only one button, e.g., the browser button, is used to navigate between the video image and the browser image (FIG. 15). Pressing the button reduces the video image continuously until the browser image completely fills the screen. Thereafter, pressing the button reduces the browser image continuously until the video image completely fills the screen, and so on. In one implementation, images are reduce or increased discretely in predetermined sizes.

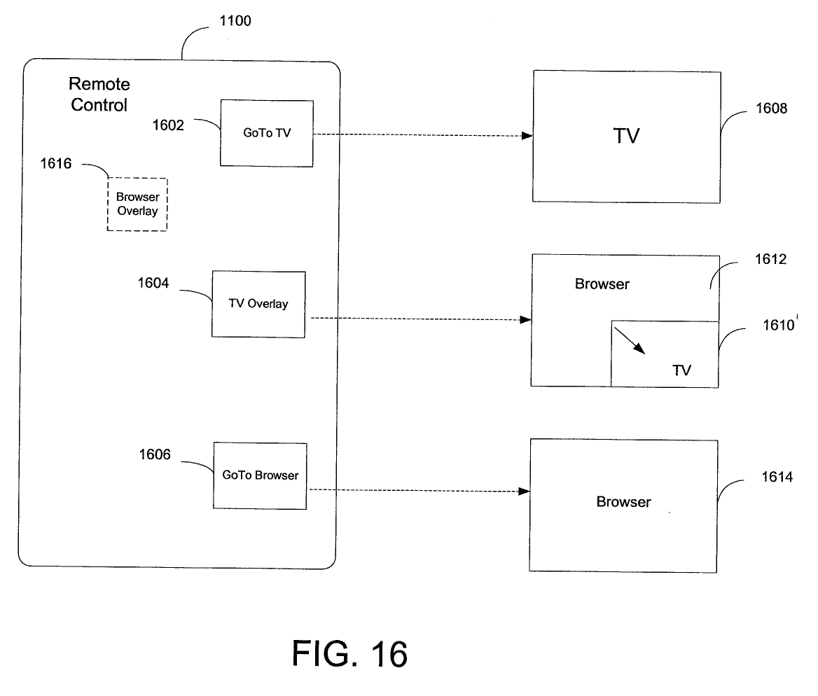

In another embodiment, as shown in FIG. 16, the remote control includes three buttons, a Go To TV button 1602, a TV Overlay button 1604, and a Go To Browser button 1606, to control the PIB mode. Pressing the Go To TV button displays a full video image 1608. Pressing the TV overlay displays a reduced video image 1610 overlaid on a browser image 1612. Pressing the Go To Browser button displays a full browser image 1614. In one implementation, when the TV Overlay button is initially pressed, the reduced video image 1610 first appears in a particular dimension, e.g., occupying one third of the display screen. The reduced video image is further reduced in size by successively pressing the TV Overlay button or keeping it pressed. Eventually, the reduced video image 1610 disappears entirely from the display screen and the browser image completely fills the screen. Thereafter, if the TV Overlay button is pressed again or is kept pressed, the reduced video image 1610 appears again in the same dimension it had first appeared on the screen, filling one third of the display screen. In another implementation, the remote control includes a Browser Overlay button 1616 that performs a similar function as the TV Overlay button, except when the former is pressed, a reduced browser image (not shown) is overlaid on a video image (not shown). The remote control may include both the Browser Overlay button and the TV Overlay button or just one of them.

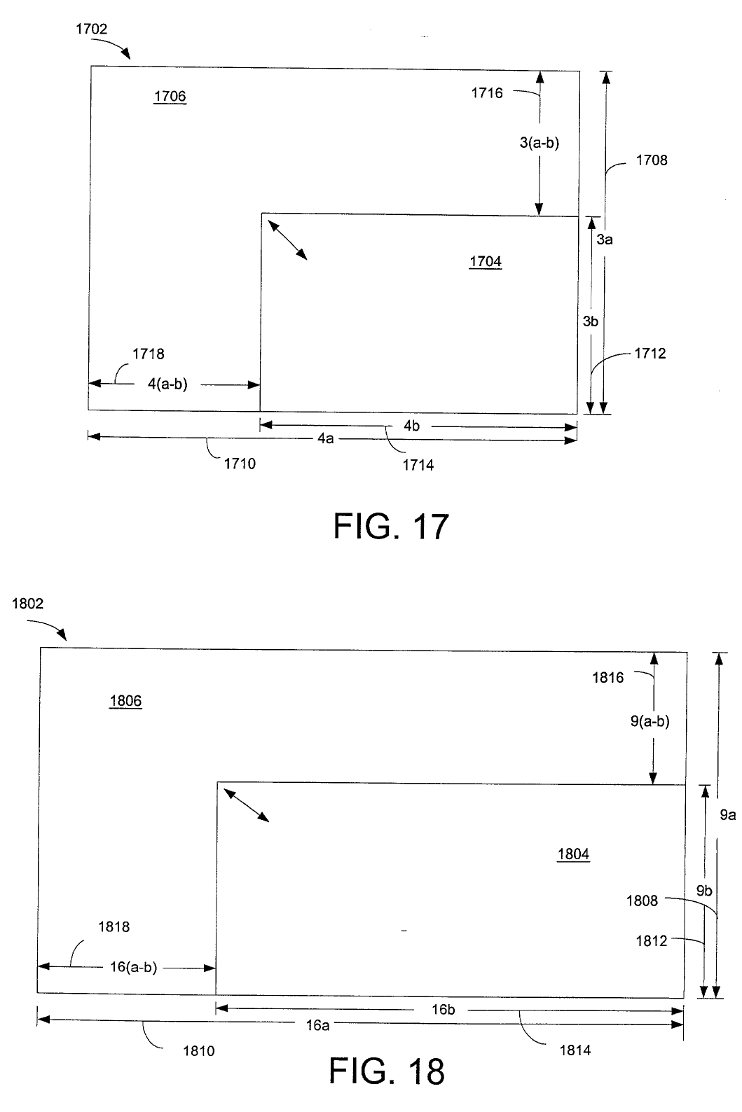

Referring to FIG. 17, in one embodiment, the video and browser images maintain a fixed length-to-width ratio as they are progressively reduced or increased in size. A display screen 1702 displays a video image 1704 (or browser image) overlaid on a browser image 1706 (or video image). The display screen has a width 1708 and a length 1710, where the width and length are “3a” and “4a,” respectively. The variable “a” is a positive number sufficiently large to provide a user with a viewing area. The display screen has a length-to-width ratio of 4:3. The full video or browser images that completely fill the screen also have the same length-to-width ratio. The images maintain this ratio as they are progressively reduced or increased in size. For example, the video image 1704 that has been reduced in size has a width 1712 and a length 1714 of “3b” and “4b,” respectively. That is, the video image 1704 has the same length-to-width ratio as the display screen.

Size of the video image is generally defined by the value of the variable “b.” The variable “b” can be any number from zero to the value of “a.” The buttons such as the browser button 1112 control the value of the variable “b.” Initially when “b” is equal to “a”, the video image completely fills the display screen and the browser image is not visible to the viewers. As the “b” is decreased by pressing the browser button, the video image is correspondingly reduced in size. The browser image, in turn, appears as a rotated “L” shape. For example, the browser image 1706 having the shape of “L” rotated in −90 degrees appears on the screen as the video image is reduced (FIG. 17). The browser image has a width 1716 and a length 1718 of “3(a-b)” and “4(a-b),” respectively. Therefore, the value of “b” also defines the shape and size of the browser image displayed on the screen.

Eventually when “b” is decreased to a zero or a value substantially close to zero, the browser image completes fills the display screen and is overlaid on the video image. As used herein, the term “value substantially close to zero” refers to value of “b” that is too small for human eyes to see. In one instance, if the browser button is pressed thereafter, the value of“b” is reset to its initial value, i.e., set to be equal to the value of “a.” That is, the entire video image is pulled forward to be overlaid on the browser image, so that only the video image is visible to the user and the browser image is hidden behind the video image.

In another instance, the values of variable “b” is assigned to define the overlaid image, whether it is a video or browser image. In addition, if the value of “b” is decreased to zero or a value that is substantially close to zero, the value of “b” is automatically reset to its initial value. From this point on, if the button is pressed and the value of “b” is decreased, the browser image is decreased rather than the video image since the browser image is now overlaid on the video image. If the value of “b” eventually is decreased to zero or a value substantially close to zero, the value of “b” is reset to its initial value again and the size of the video image is varied according to the value of “b,” and so on. In other instances, the value of “b” may be made to depend on the Smaller TV button 1406 and Bigger TV button 1408, where pressing the Smaller TV button decreases the value of “b” and pressing the Bigger TV button increases the value of “b.”

Referring to FIG. 18, in another embodiment, the video and browser images maintain a different fixed length-to-width ratio as they are progressively reduced or increased in size. A display screen 1802 displays a video image 1804 (or browser image) overlaid on a browser image 1806 (or video image). The display screen has a width 1808 and a length 1810, where the width and length are “9a” and “16a”, respectively. The display screen has a length-to-width ratio of 16:9. The images maintain this ratio as they are being reduced or increased in size. For example, when the remote control is used to reduce the size of the full video image, the screen displays the video image 1804 having a width 1812 and a length 1814 of “16b” and “9b,” respectively. That is, the video image 1804 has the length-to-width ratio of 16:9. The screen also displays the browser image 1806 having the shape of “L” rotated in −90 degrees as a result of the reduction of the video image. The browser image 1806 has a width 1816 and a length 1818 of “9(a-b)” and “9(a-b),” respectively. The size of the video image is defined by the value of “b” and is adjusted accordingly by varying the value of “b,” as described above.

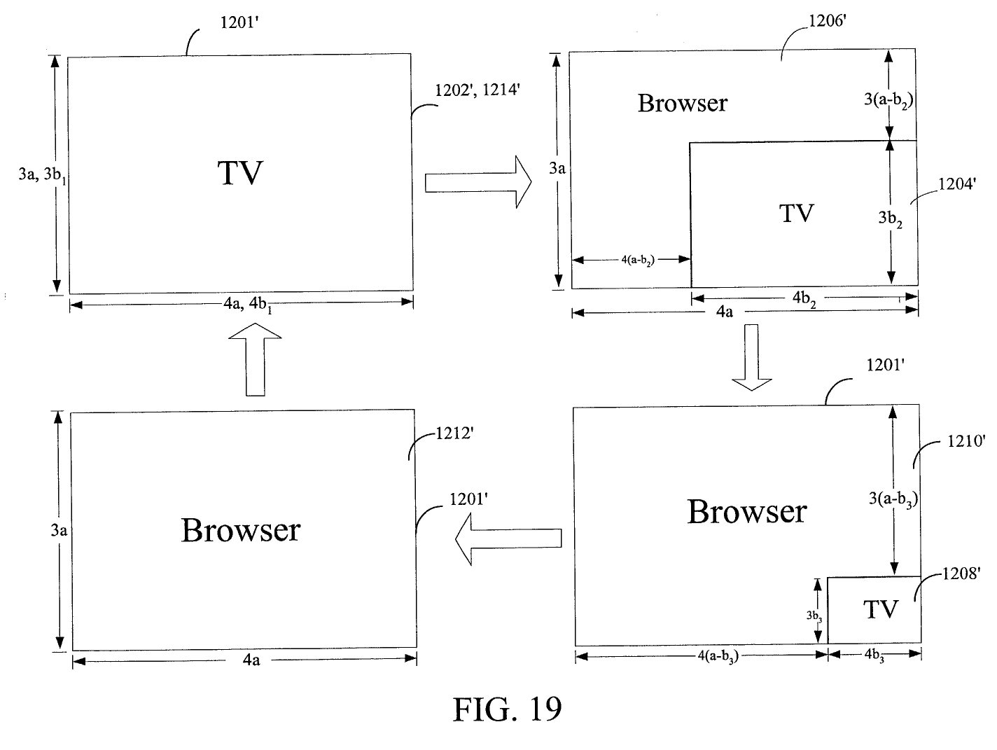

FIG. 19 illustrates an exemplary implementation of the above embodiment to the embodiment disclosed in connection with FIG. 12. The elements in FIG. 19 are provided with primes at the end of the numbers to differentiate them from the elements in FIG. 12. A display screen 1201′ initially displays a full video image 1202′ that completely fills the screen having a width of “3a” and a length of “4a,” where “a” is a positive number. The width and length of the video image are defined by a variable “b,” where the video image 1202′ has a width of “3b₁” and a length of “4b₁.” The value of “b₁,” i.e., initial value of “b,” is equal to the value of “a.” The display screen and video image 1202′ both have the same length-to-width ratio of 4:3.

If the browser button 1112 is pressed once, “b₁” is decreased to “b₂.38 The display screen consequently displays a reduced video image 1204′ overlaid on a browser image 1206′ of first size. The video image 1204′ has a width of “3b₂” and a length of “4b₂.” The reduced video image 1204′ maintains the same length-to-width ratio as the initial video image 1202′. If the button is pressed again, the variable “b₂” is decreased to “b₃.” As a result, the screen displays a further reduced video image 1208′ and a browser image 1210′ of second size. The video image 1208′ has a width of “3b₃” and a length of “4b₃.” The video image 1208′ continues to maintain the length-to-width ratio of 4:3. If the button is pressed once again, “b₃” is decreased to “b₄,” where b₄” is zero or a value substantially close to zero. The display screen 1201 is completely filled with a browser image 1212′. At this point, if the browser button is pressed yet again, the “b₄” is reset to “b₁” which is the initial value of the variable. Consequently, a full video image 1214′ replaces the browser image 1212′ to completely fill the screen 1201′, thereby returning to the initial state.

While specific embodiments and applications of the present invention have been illustrated and described, it is to be understood that the invention is not limited to the precise configuration and components disclosed herein. Various modifications, changes, and variations which will be apparent to those skilled in the art may be made in the arrangement, operation, and details of the methods and systems of the present invention disclosed herein without departing from the spirit and scope of the invention. For example, implementations and alternatives thereto provided for a particular embodiment may be implemented for other embodiments. Therefore, the scope of the present invention is to be interpreted using the claims provided below.

What is claimed is:

1. A method of viewing multi-media content on a television having a display area, comprising:
providing a remote control to control images being displayed on the display area;
displaying a first image of first type on the display area, the first image substantially filling the display area and having a first length and a first width, the first image having a first length-to-width ratio;
initiating a first instruction on the remote control to modify the first image being displayed on the display area; and
displaying on the display area a reduced image of the first image overlaid on a second image of second type in response to the first instruction, the reduced image of the first image having a second length and a second width and having a second length-to-width ratio, wherein the first and second values of the length-to-width ratio being substantially the same.

2. The method of claim 1, further comprising:
filling the display area with the second image of second type in response to a second instruction initiated with the remote control; and
displaying on the display area a reduced image of the second image overlaid on the first image in response to a third instruction initiated with the remote control.

3. The method of claim 2, wherein the first image of first type is a video image and the second image of second type is a browser image.

4. The method of claim 2, wherein the first image of first type is a browser image and the second image of second type is a video image.

5. The method of claim 2, wherein the remote control has a single button to input the instructions.

6. A method of viewing multi-media content on a television having a display area, comprising:
providing a remote control having an input mechanism;
displaying a first image of first type on the display area, the first image having a first size and being overlaid on a second image of second type, so that the second image is not visible to a user viewing the display area, the first image with the first size having a first length-to-width ratio;
initiating a first instruction with the input mechanism; and
reducing the first image with the first size to a second size in response to the first instruction, so that the second image is partially displayed on the display area, the first image with the second size having a second length-to-width ratio that is substantially the same as the first length-to-width ratio.

7. The method of claim 6, the method further comprising:
initiating a second instruction using the input mechanism of the remote control;
in response to the second instruction, reducing the size of the first image being displayed on the display area until the first image is no longer visible on the display area; and
thereafter, increasing the size of the first image being displayed on the display area until the first image substantially fills the display area.

8. The method of claim 7, wherein the input mechanism of the remote control is a button.

9. The method of claim 7, wherein the input mechanism of the remote control has a first button and a second button, where the first button decreases the size of the first image being displayed on the display area, and the second button increases the size of the second image being displayed on the display area.

10. A method of viewing multi-media content on a television having a display area, comprising:
providing a remote control having an input mechanism;
displaying a first image of first type on the display area, the first image having a first size and being overlaid on a second image of second type, so that the second image is not visible to a user viewing the display area, the first image with the first size having a first length-to-width ratio, wherein a size of the first image of first type is defined by a variable b with an initial value b1;
initiating a first instruction with the input mechanism;
decreasing the value of b from b1 to b2 in response to the first instruction; and
reducing the first image with the first size to a second size in response to the decrease in the value of b, so that the second image is partially displayed on the display area, the first image with the second size having a second length-to-width ratio that is substantially the same as the first length-to-width ratio.

11. The method of claim 10, further comprising:
initiating a second instruction using the input mechanism of the remote control;
decreasing the value of b from b2 to b3 in response to the second instruction; and
in response to the decrease in the value of b, reducing the size of the first image being displayed on the display area until the first image is no longer visible on the display area.

12. The method of claim 11, further comprising:
initiating a third instruction using the input mechanism of the remote control;
resetting the value of b to b1 in response to the third instruction; and
thereafter, displaying the first image overlaid on the second image in response to the adjustment of the value of b to b1, the first image substantially filling the display area so that the second image is no longer visible on the display area.

13. The method of claim 10, wherein the input mechanism of the remote control is a button.

14. The method of claim 10, wherein the input mechanism of the remote control has a first button and a second button, where the first button decreases the value of b and the second button increases the value of b.

15. The method of claim 1, wherein the second length-to-width ratio is 4:3.

16. The method of claim 1, wherein the second length-to-width ratio is 16:9.

17. The method of claim 6, wherein the second length-to-width ratio is 4:3.

18. The method of claim 6, wherein the second length-to-width ratio is 16:9.

19. The method of claim 10, wherein the second length-to-width ratio is 4:3.

20. The method of claim 10, wherein the second length-to-width ratio is 16:9.
